(19) United States
(12) Patent Application Publication
(10) Pub. No.: US 2018/0199542 A1
(43) Pub. Date: Jul. 19, 2018

(54) TIP-PROOF FEEDING BOWL FOR HOUSE PETS

(71) Applicants: KENNETH L. FOSTER, BRIGHTON, MI (US); MEGAN E. FOSTER, BRIGHTON, MI (US)

(72) Inventors: KENNETH L. FOSTER, BRIGHTON, MI (US); MEGAN E. FOSTER, BRIGHTON, MI (US)

(73) Assignee: GREEN OAK TECHNOLOGY GROUP LLC, BRIGHTON, MI (US)

(21) Appl. No.: 15/731,531

(22) PCT Filed: Apr. 15, 2016
(86) PCT No.: PCT/US16/27796

§ 371 Date: Jun. 26, 2017

Related U.S. Application Data
(60) Provisional application No. 62/174,189, filed on Jun. 11, 2015.

(51) Int. Cl. A01K 5/01

(52) U.S. Cl. CPC A01K 5/0135

(57) ABSTRACT

An improved feeding bowl for household pets having a central portion for placement of food or water surrounded by a first annular wall upwardly disposed joining a second annular wall downwardly disposed, wherein the first and second annular walls meet at an angle, θ₂, ranging from about 5 to about 120 degrees to facilitate stacking of multiple bowls, wherein said second downwardly disposed annular wall engages a peripheral portion of the bowl, or apron, having a radial extent, L₁, sufficient to cause the household pet to stand on the apron in order to feed wherein said apron engages the surface upon which the bowl is disposed at an angle, θ₁, ranging from 0 to about 30 degrees.

### CROSS-REFERENCE TO RELATED APPLICATIONS

This application claims priority to U.S. Provisional patent application Ser. No. 62/174,189 filed Jun. 11, 2015 and incorporated by reference herewith in its entirety.

### FIELD OF THE INVENTION

The present invention relates to an improved apparatus, namely a feeding bowl that is suitable for use by house pets wherein the improvement comprises a more stable configuration of the feeding, bowl that is more resistant to tipping.

### BACKGROUND OF THE INVENTION

House pets such as cats, dogs, mice, hamsters, guinea pigs, white rats, lizards and other small vertebrate animals (hereinafter collectively pets and in the singular pet) are generally fed or watered by placing their food or water in a bowl disposed on the floor of the house or the surface or floor of their cage. A common problem associated with pet bowls is that they can easily be tipped over spilling the contents and creating additional housekeeping issues for the pet owner. The problem of animal pet bowls tipping and spilling contents is further aggravated by the usual materials of manufacture of such bowls, e.g. thermoplastics, which render them light weight and thus easily moved and tipped over by a small animal resulting in spilling the contents.

Pet food bowls are usually left unattended for long periods of time and as a result, spills of pet food or water can remain on the floor of the home or the cage housing the pet aggravating house cleaning or cage cleaning issues for the owner. Spilled pet food can also be a nuisance attracting insects and vermin creating additional health and maintenance issues for the pet owner.

### SUMMARY OF THE INVENTION

The present invention solves the tipping problem associated with pet food bowls by providing a wide base or apron surrounding the bowl that engages the floor preferably at an angle greater than zero degrees. The bowl of the present invention is further improved by having the wails of the feeding bowl so disposed that multiple bowls are stackable one upon the other. Rendering the pet feeding bowl stackable facilitates both the manufacture and shipping of the bowls from the point of manufacture to the point of sale to the pet owner by reducing the volume of any shipping container or shelf space at a retailer. The present invention overcomes the light weight of the usual materials of manufacture of such a pet feeding bowl by being configured so that the weight of the animal is utilized to stabilize the bowl when the animal is feeding.

Thus the present invention provides for an improved feeding bowl for household pets having a central portion for placement of food or water said central portion surrounded by a first annular wall upwardly disposed joining a second annular wall downwardly disposed, wherein the first and second annular walls meet at an angle, θ₂, ranging from about 5 to about 120 degrees to facilitate stacking of multiple bowls, wherein said second downwardly disposed annular wall engages a third annular or peripheral portion of the bowl, or apron, having a radial extent, L₁, sufficient to cause a household pet having forelegs and hindlegs wherein the forelegs of the household pet engage the apron of the feeding bowl in order to feed wherein said apron engages a surface upon which the bowl is disposed at an angle, θ₁, ranging from 0 to about 30 degrees.

The present invention further provides for an improved feeding bowl for household pets having a central portion for placement of food or water said central portion surrounded by a first annular wall upwardly disposed joining a second annular wall downwardly disposed, wherein the first and second annular walls meet at an angle, θ₂, ranging from about 5 to about 120 degrees to facilitate stacking of multiple bowls, wherein said second downwardly disposed annular wall engages a third annular or peripheral portion of the bowl, or apron comprising at least one step, having a radial extent, L₁, said radial extent sufficient to cause a household pet having forelegs and hindlegs wherein the forelegs of the household pet engage the apron of the feeding bowl in order to feed wherein said apron engages a surface upon which the bowl is disposed at an angle, θ₁, ranging from 0 to about 30 degrees.

The present invention further provides for square, rectangular or polygonal feeding bowls for household pets manufactured from a variety of materials.

### BRIEF DESCRIPTION OF THE DRAWINGS

FIG. 1 Top perspective view of the bowl;

FIG. 2 Bottom perspective view of the bowl;

FIG. 3 Cross-sectional view of the bowl with dimension L₁, and angles θ₁, θ₂, and θ₃ identified;

FIG. 4 Cross-sectional view of the bowl showing three bowls stacked one on top of the other;

FIG. 5 Composite view of a side elevation of the bowl combined with a cross-sectional view.

FIG. 6 Cross-sectional view of a second embodiment of the bowl wherein the apron has at least one step with dimensions H₁, L₂, L₃ and angles θ₂, and θ₃identified;

FIG. 7 Cross-sectional view of the second embodiment of the bowl showing three bowls stacked one on top of the other and angles θ₂, and θ₃ identified;

FIG. 8 Cross-sectional view of the second embodiment of the bowl with the angle, θ₁, identified and wherein θ₁ is greater than zero.

FIG. 9 Cross-sectional view of the second embodiment of the bowl wherein three bowls are stacked one on top of another and wherein θ₁ is greater than zero.

FIG. 10 Cross-sectional view of a third embodiment of the bowl with dimension L₄, and angles θ₁, θ₂, and θ₃ identified; and

FIG. 11 Cross-sectional view of a third embodiment of the bowl showing three bowls stacked one on top of the other.

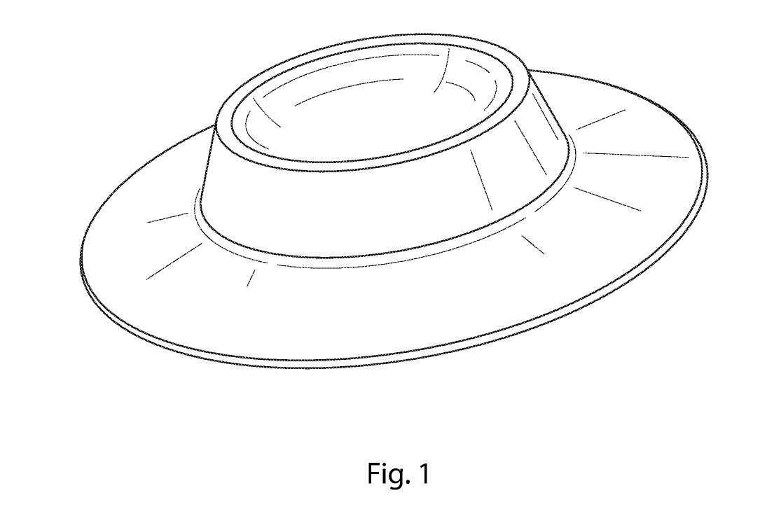

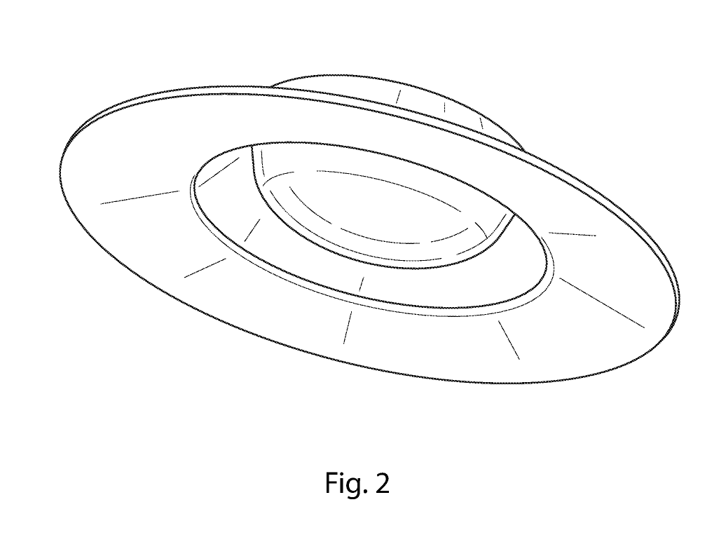

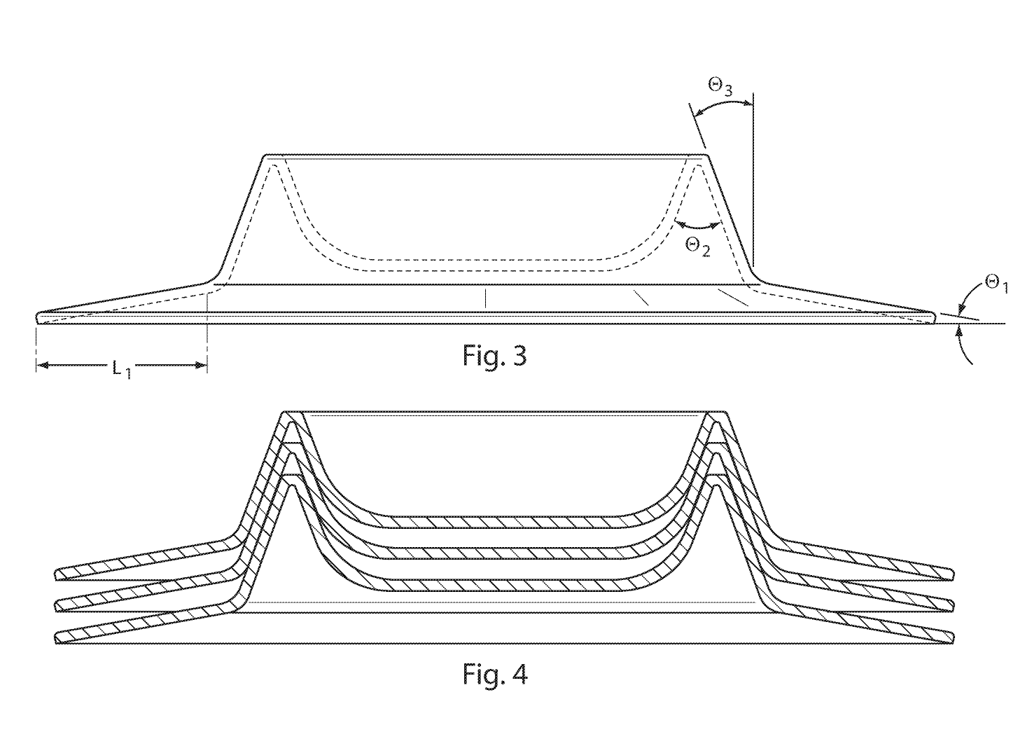

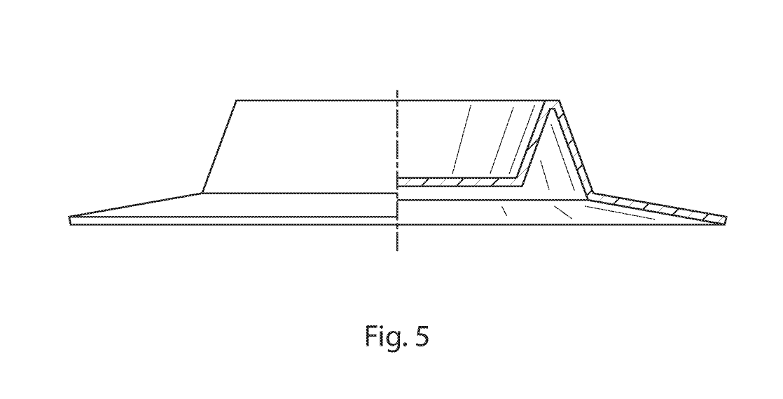

### DETAILED DESCRIPTION OF THE INVENTION

In a circular or cylindrical first embodiment of the present invention, the instant feeding bowl has a central portion that forms a bowl and a peripheral portion or apron that slopes downwardly. In the circular embodiment of the pet feeding bowl, the radius is conveniently chosen for the quantity of food or water to be delivered to the animal using the bowl. The peripheral portion or apron, is sized, i.e. has sufficient radial extent, L₁, so that the forelegs of the animal must be engaged with the apron by standing thereon in order to feed from the bowl. In this fashion the weight of the animal is used to stabilize to bowl and thus prevent it from tipping. A useful dimension in this respect as regards the radial extent of the apron is to have a radial length from the outer edge of the bowl to the outer edge of the apron. L₁, that is greater than one quarter or twenty-five (25) percent to one half or fifty (50) percent of the average length of the animal from its forelegs to its hindquarters. This is most easily accomplished when the bowl is used for feeding small vertebrate animals such as small rodents, for example guinea pigs, hamsters and the like. In the case of larger animals, specifically cats and dogs and the like, the radial extent of the apron should again be sized to use the weight of the animal to prevent tipping but for such larger animals a different length parameter is more suitable, that of the length from the front of the head to the shoulders, preferably again half that length or greater.

The apron of the bowl may contact the floor on which the bowl is disposed at any angle, θ₁, from 0 degrees to about 30 degrees, but preferably from slightly greater than 0 degrees to about 30 degrees, more preferably from about 5 degrees to about 25 degrees and most preferably from about 10 degrees to about 20 degrees.

More specifically the dish of the present invention includes an inner central portion or base that may be either flat or a chord of a sphere extending either laterally or radially to a first inner annular wall (interior wall) extending upwardly and a second outer annular wall (exterior wall) extending downwardly from a junction with the first annular wall, said junction defining the rim of the feeding bowl at an angle, θ₂, to facilitate stacking of the bowl one on top of the other and a third annular segment extending radially outward from the second or outer annular wall, the so-called apron, that engages the surface, or floor, on which the bowl is disposed at an angle, θ₁. The inner central portion of the bowl is that part of the feeding bowl that comprises or defines that portion of the bowl intended to contain food or water and when circular may have any convenient radius (or diameter). The apron extends peripherally from the second annular wail and the range of that extent is not necessarily related to the radius of the central portion, the radial extent of the apron being governed more by the size of the animal being fed, i.e. using the bowl to feed.

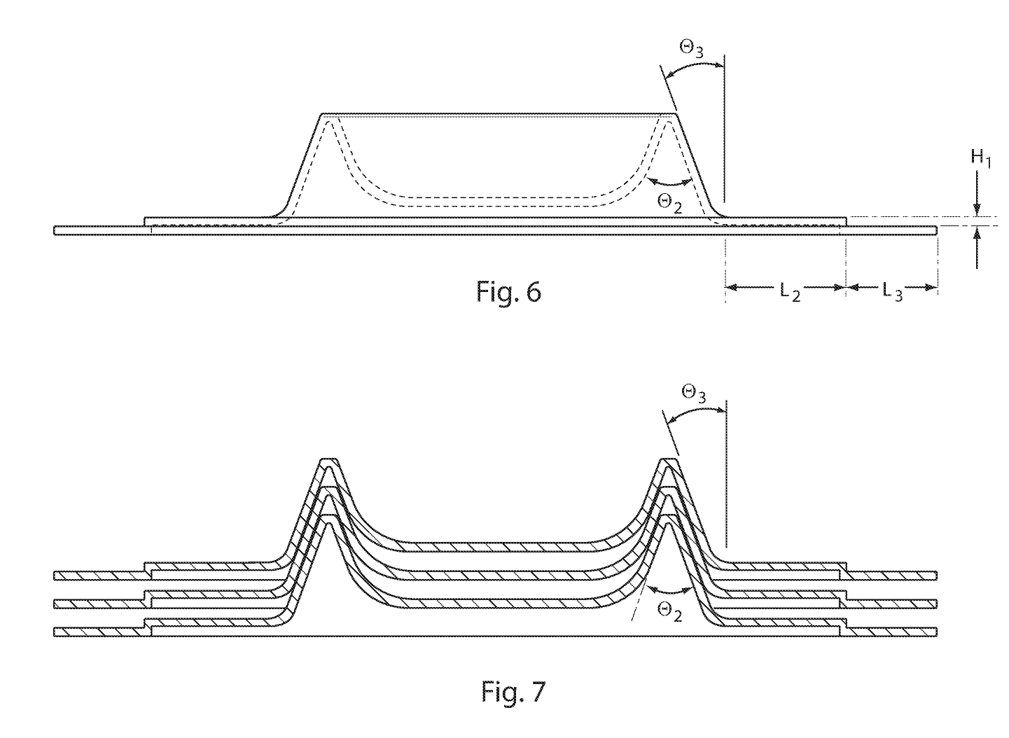

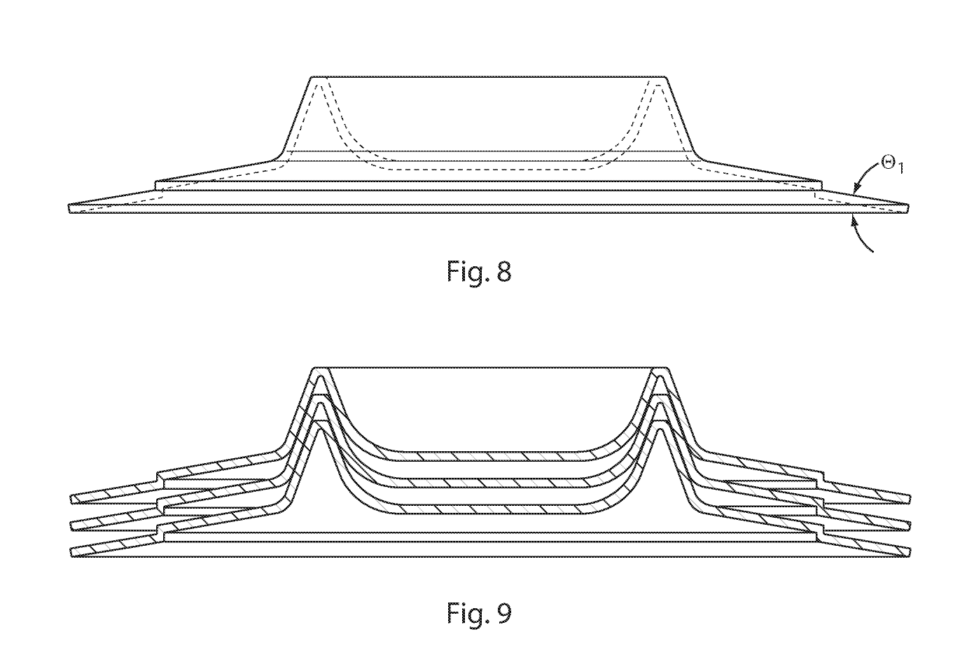

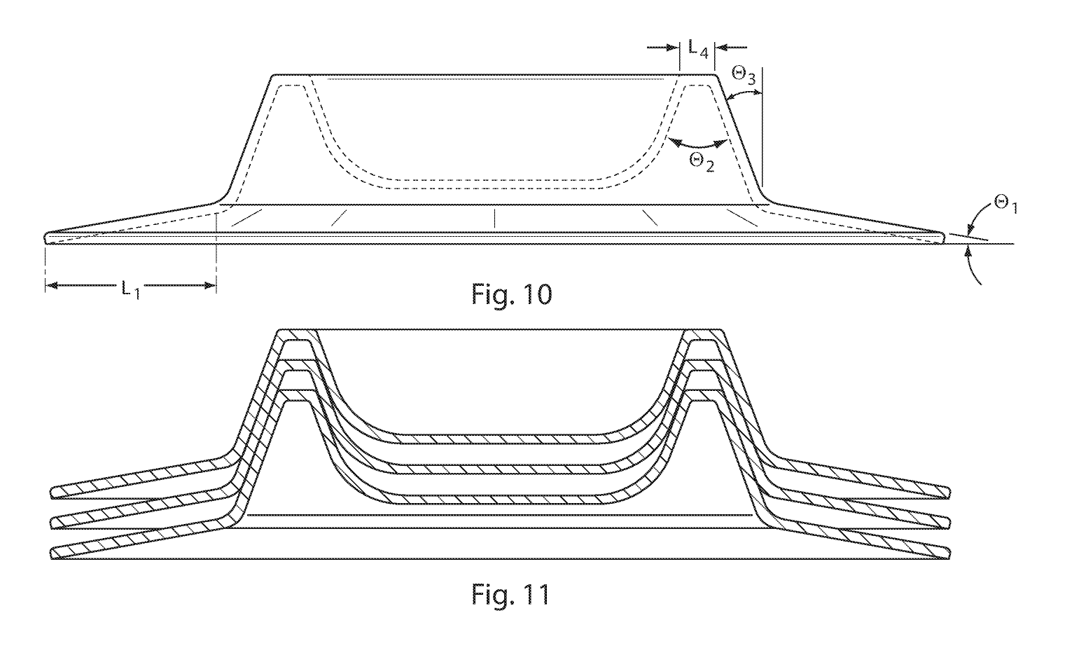

The alternative or second embodiment shown in FIGS. 6 through 7 show an embodiment wherein the apron is stepped, having at least one step. In the particular embodiment shown the stepped embodiment comprising at least one step comprises two flat segments L₂ and L₃, with at least one step of height, H₁, there between and with respect to the radial extent of the flat segments the sum of the lengths of L₂ and L₃ should be comparable or equal to L₁ in the first embodiment in order that the radial extent of the apron has a radial length from the outer edge of the bowl to the outer edge of the apron, L₂ plus L₃, that is greater than one quarter or twenty-five (25) percent to about half or fifty (50) percent of the average length of the animal from its forelegs to its hindquarters. This is most easily accomplished when the bowl is used for feeding small vertebrate animals such as small rodents, for example guinea pigs, hamsters and the like. In the case of larger animals, specifically cats and dogs and the like, the radial extent of the apron should again be sized to use the weight of the animal to prevent tipping but for such larger animals a different length parameter is more suitable, that of the length from the front of the head to the shoulders, preferably again half that length or greater. For the embodiment involving a stepped apron, the height of the step, H₁, should not be more than the average range of motion of the foreleg of the type of animal using the bowl, usually this will range from about ⅛ (0.125) inch to more than about two (2) inches. H₁ is the height of the step between radial segments L₂ and L₃ of the apron. For the stepped embodiment it should be noted that the angle of contact, θ₁, in the first embodiment may the same or different for each segment L₂ and L₃. In those versions of the stepped embodiment wherein there is more than one step there will be radial segments corresponding to the additional steps where the number of radial segments Lₓ is a function of the number of steps, where n is the number of steps, n, equal to n plus 1 (n+1), thus for an embodiment with two steps there will be three radial segments L₂+L₃+L₄ and two step heights H₁ that may be the same or different.

While the radial length parameters L₁ or L₂+L₃ of the apron establish a quantitative basis for the radial extent of the apron of the bowl of the present invention as demonstrated in Table I, it is sufficient in a qualitative sense that the radial extent of the apron extend outwardly from the downwardly extending second annular wall sufficiently so that the animal using the bowl to feed or drink must stand either in whole or in part on the apron, engaging at a minimum its forelegs upon the apron, in order to feed or drink. The bowl is thereby stabilized against tipping by the weight of the animal as it stands with its forelegs upon the apron.

A third embodiment of the bowl of the present invention differs from the first two embodiments in that the upwardly extending inner first annular wall meets or engages a rim that is parallel to the surface on which the bowl is disposed, said rim extending radially a distance, L4, which then meets or engages the downwardly extending second annular wall, all other components of the bowl remaining essentially or substantially the same.

A fourth embodiment of the bowl as exemplified by the third embodiment is provided wherein the apron is stepped, having at least one step. In the particular the step of the apron of the fourth embodiment comprises two flat segments L₂ and L₃, with one step of height, H₁ there between.

The first, second and third embodiments specifically describe a circular bowl as is described and shown in the attached figures. However the bowl is not required to be circular, it may be any number of different geometrical shapes, square, rectangular, polygonal and the like, provided the interior and exterior walls of the bowl meet at an angle, θ₂, ranging from about 5 to 120 about degrees, more preferably from about 25 to about 100 degrees and most preferably from about 30 to about 50 forming a rim that facilitates stacking, and the apron engages the surface on which the bowl is disposed at an angle, θ₁.

The bowl of the present invention may be manufactured from a variety of materials from which bowls generally are manufactured among others but not limited to: china, earthenware, porcelain, glass, wood, metal particularly stainless steel, and plastics, particularly thermoplastics. The thermoplastic materials may be selected from any thermoplastic materials routinely used in thermoforming, extrusion molding or injection molding of objects. A representative list of thermoplastic polymers, polymers and terpolymers includes, but is not limited to: acrylate, methacrylate, acrylonitrile-butadiene-styrene, nylon, polybenzimidazole, polycarbonate, polyethersulfone, polyetheretherketone, polyetherimide, polyethylene, polyphenylene oxide, polyphenylene sulfide, polypropylene, polystyrene, polyvinyl chloride, polytetrafluoroethylene, polyacetal, cellulosic polymers, polyamides, polyamide-imide, polyaryletherketone, polyketone, polyethylene chlorinates, polybutylene, polyisobutylene, polyvinylidene chloride and mixtures thereof.

While they are not thermoplastics, silicone polymers may also be used to form the bowl of the present invention. Addition curable silicones, involving an olefinically terminated silicone oligomers and a hydride terminated silicone oligomer, either one or both further comprising a Pt or Rh addition curing catalyst can be separately fed into an injection molding device molded to the contours of the bowl of the present invention and cured in the molding cavity. Condensation polymers of silicones may also be used.

The bowl of the present invention may be manufactured by any one of several processes known in the art in manufacturing useful articles from polymeric materials such as thermoforming, injection molding, blow molding, rotational molding and the like. Thermoforming is a manufacturing process where a plastic sheet is heated to a pliable forming temperature, formed to a specific shape in a mold, and trimmed to create a usable product. The sheet, or “film” when referring to thinner gauges and certain material types, is heated in an oven to a high-enough temperature that permits it to be stretched into or onto a mold and cooled to a finished shape. A simplified version of thermoforming involves using a vacuum to drawn the sheet over the mold. In complex and high-volume applications, very large production machines are utilized to heat and form the plastic sheet and trim the formed parts from the sheet in a continuous high-speed process, and can produce many thousands of finished parts per hour depending on the machine and mold size and the size of the parts being formed.

Thermoforming differs from injection molding, blow molding rotational molding and other forms of processing plastics. Thin-gauge thermoforming is primarily the manufacture of disposable cups, containers, lids, trays, blisters, clamshells, and other products for the food, medical, and general retail industries. Thick-gauge thermoforming includes parts as diverse as vehicle door and dash panels, refrigerator liners, utility vehicle beds, and plastic pallets.

In the most common method of high-volume, continuous thermoforming of thin-gauge products, plastic sheet is fed from a roll or from an extruder into a set of indexing chains that incorporate pins, or spikes, that pierce the sheet and transport it through an oven for heating to forming temperature. The heated sheet then indexes into a form station where a mating mold and pressure-box close on the sheet, with vacuum then applied to remove trapped air and to pull the material into or onto the mold along with pressurized air to form the plastic to the detailed shape of the mold. (Plug-assists are typically used in addition to vacuum in the case of taller, deeper-draw formed parts in order to provide the needed material distribution and thicknesses in the finished parts.) After a short form cycle, a burst of reverse air pressure is actuated from the vacuum side of the mold as the form tooling opens, commonly referred to as air-eject, to break the vacuum and assist the formed parts off of, or out of, the mold. A stripper plate may also be utilized on the mold as it opens for ejection of more detailed parts or those with negative-draft, undercut areas. The sheet containing the formed parts then indexes into a trim station on the same machine, where a die cuts the parts from the remaining sheet web, or indexes into a separate trim press where the formed parts are trimmed. The sheet web remaining after the formed parts are trimmed is typically wound onto a take-up reel or fed into an inline granulator for recycling.

Most thermoforming companies recycle their scrap and waste plastic, either by compressing in a baling machine or by feeding into a granulator (grinder) and producing ground flake, for sale to reprocessing companies or re-use in their own facility. Frequently, scrap and waste plastic from the thermoforming process is converted back into extruded sheet for forming.

Injection molding is a manufacturing process for producing parts by injecting material into a mold. Injection molding can be performed with a host of materials, including metals, glasses, elastomers, metals, glasses, elastomers, thermoplastic and thermosetting polymers. Material for the part is fed into a heated barrel, mixed, and forced into a mold cavity, where it cools and hardens to the configuration of the cavity. Parts to be injection molded must be very carefully designed to facilitate the molding process; the material used for the part, the desired shape and features of the part, the material of the mold, and the properties of the molding machine must all be taken into account. The versatility of injection molding is facilitated by this breadth of design considerations and possibilities.

Injection molding is used to create many things such as wire spools, packaging, bottle caps, automotive parts and components, Gameboys, pocket combs, some musical instruments (and parts of them), one-piece chairs and small tables, storage containers, mechanical parts (including gears), and most other plastic products available today. Injection molding is the most common modern method of manufacturing parts; it is ideal for producing high volumes of the same object.

Injection molding uses a ram or screw-type plunger to force molten plastic material into a mold cavity; this solidifies into a shape that has conformed to the contour of the mold. Injection molding is most commonly used to process both thermoplastic and thermosetting polymers, with the former being considerably more prolific in terms of annual material volumes processed. Thermoplastics are prevalent due to characteristics which make them highly suitable for injection molding, such as the ease with which they may be recycled, their versatility allowing them to be used in a wide variety of applications, and their ability to soften and flow upon heating. Thermoplastics also have an element of safety over thermosets; if a thermosetting polymer is not ejected from the injection barrel in a timely manner, chemical crosslinking may occur causing the screw and check valves to seize and potentially damaging the injection molding machine.

Injection molding consists of high pressure injection of the raw material into a mold which shapes the polymer into the desired shape. Molds can be of a single cavity or multiple cavities. In multiple cavity molds, each cavity can be identical and form the same parts or can be unique and form multiple different geometries during a single cycle. Molds are generally made from tool steels, but stainless steels and aluminum molds are suitable for certain applications. Many steel molds are designed to process well over a million parts during their lifetime and can cost hundreds of thousands of dollars to fabricate.

When thermoplastics are molded, typically pelletized polymeric material is fed through a hopper into a heated barrel with a reciprocating screw. The screw delivers the raw material forward, mixes and homogenizes the thermal and viscous distributions of the polymer, and reduces the required heating time by mechanically shearing the material and adding a significant amount of frictional heating to the polymer. The material feeds forward through a check valve and collects at the front of the screw into a volume known as a shot. A shot is the volume of material that is used to fill the mold cavity, compensate for shrinkage, and provide a cushion (approximately 10% of the total shot volume, which remains in the barrel and prevents the screw from bottoming out) to transfer pressure from the screw to the mold cavity. When enough material has gathered, the material is forced at high pressure and velocity into the part forming cavity. To prevent spikes in pressure, the process normally uses a transfer position corresponding to a 95-98% full cavity where the screw shifts from a constant velocity to a constant pressure control. Often injection times are well under 1 second. Once the screw reaches the transfer position the packing pressure is applied, which completes mold filling and compensates for thermal shrinkage, which is quite high for thermoplastics relative to many other materials. The packing pressure is applied until the gate (cavity entrance) solidifies. Due to its small size, the gate is normally the first place to solidify through its entire thickness. Once the gate solidifies, no more material can enter the cavity; accordingly, the screw reciprocates and acquires material for the next cycle while the material within the mold cools so that it can be ejected and be dimensionally stable. This cooling duration is dramatically reduced by the use of cooling lines circulating water or oil from a thermolator. Once the required temperature has been achieved, the mold opens and an array of pins, sleeves, strippers, etc. are driven forward to demold the article. Then, the mold closes and the process is repeated.

As hereinbefore set forth, the optimal size of the bowl of the present invention varies with the size of the pet as defined by the two apron length parameters L₁ or the sum of L₂ and L₃, depending on whether or not the apron is stepped, Table I.

TABLE I
APPROXIMATE SIZES OF VARIOUS HOUSE PETS

| | | | | | L₁ or L₂ + L₃ | |
|---|---|---|---|---|---|---|
| | Length (inches) | | | Length | range in inches | |
| | | Aver- | | includes | quarter | half |
| Animal | Minimum | age | Maximum | tail | length | length |
| Mice | 6 | | 12 | Yes | 1.5-3 | 3-6 |
| Hamster | 3 | | 7 | No | 0.75-1.75 | 2-3.5 |
| Guinea | 4 | | 12 | No | 1-3 | 2-6 |
| pig | | | | | | |
| Cat | 10 | 18 | 36 | No | 2.5-9.0 | 5-18 |

As can be seen from Table I the radial extent of the apron of the bowl of the present invention for a larger house pet such as a cat becomes very large and unwieldy which is the reason the radial extent or apron length, L₁ or L₂+L₃, is or should be based on the animal's height.

TABLE II
APPROXIMATE SIZES OF VARIOUS DOG BREEDS
(SELECTED EXAMPLES)

| | | | L₁ or L₂ + L₃ | |
|---|---|---|---|---|
| | Length | Height | quarter | half |
| Dog Breed | Average (inches) | Range (inches) | length | length |
| Chihuahua | 6 | 6-9 | 1.5 | 1 |
| Scottish Terrier | 13 | 10-11 | 3.25 | 6.5 |
| Border Collie | 17 | 17-24 | 4.25 | 12 |
| Labrador | 22-30 | 22-26 | 5.5 | 6.5 |
| Retriever | | | | |

As can be seen from the dimensions of the larger dog breeds in Table II use of a half length criterion in determining the radial extent of the apron causes the feeding dish to be become overly large in terms of total diameter. Thus while the use of the quantitative parameters L₁ or L₂+L₃ may be suitable in setting the radial extent of the apron of the feeding bowl for feeding bowls for small animals it becomes unwieldy in determining the radial extent of the apron for a feeding bowl for a larger animal such as a large breed dog. Thus qualitative considerations become more important. It is a feature of the bowl of the present invention that the apron of the bowl have sufficient radial extent wherein the animal being fed must stand on the apron so that the forelegs of the animal engage the apron when the animal is feeding from the bowl wherein the weight of the animal stabilizes the feeding bowl against tipping. The parameters L₁ or L₂+L₃ have been developed to make the determination of the radial extent of the apron of the bowl more quantitative but ultimately the qualitative aspect that the animal stand on the apron is what contributes to the stability of the bowl against tipping.

The appended claims are intended to claim the invention as broadly as it has been conceived and the examples herein presented are illustrative of selected embodiments from a manifold of all possible embodiments. Accordingly it is Applicants' intention that the appended claims are not to be limited by the choice of embodiments utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. Such ranges may be viewed as a Markush group or groups consisting of differing pairwise numerical limitations which group or groups is or are fully defined by its lower and upper bounds, increasing and/or decreasing at single integers increments from lower endpoints to upper endpoints. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims. All United States patents (and patent applications) referenced herein are herewith and hereby specifically incorporated by reference in their entirety as though set forth in full.

1. An improved feeding bowl for household pets having a central portion for placement of food or water said central portion surrounded by a first annular wall upwardly disposed joining a second annular wall downwardly disposed at a vertex or rim, wherein the first and second annular walls meet at an angle, θ₂, ranging from about 5 to about 120 degrees to facilitate stacking of multiple bowls, wherein said second downwardly disposed annular wall engages a third annular or peripheral portion of the bowl, or apron, having a radial extent, L₁, said radial extent sufficient to cause a household pet having forelegs and hindlegs to stand on the apron engaging the apron with the forelegs of the household pet in order to feed wherein said apron engages a surface upon which the bowl is disposed at an angle, θ₁, ranging from 0 to 30 degrees.

2. The bowl of claim 1 wherein the angle, θ₁, ranges from1 degree to 30 degrees.

3. The bowl of claim 1 wherein the bowl is circular.

4. The bowl of claim 1 wherein the bowl is square.

5. The bowl of claim 1 wherein the bowl is rectangular.

6. The bowl of claim 1 comprises a material of manufacture selected from the group consisting of china earthenware, porcelain, glass, wood, metal, and thermoplastics.

7. The bowl of claim 6 wherein the material is a thermoplastic.

8. An improved feeding bowl for household pets having a central portion for placement of food or water said central portion surrounded by a first annular wall upwardly disposed joining a second annular wall downwardly disposed, wherein the first and second annular wails meet at an angle, θ₂, ranging from 5 to 120 degrees to facilitate stacking of multiple bowls, wherein said second downwardly disposed annular wall engages a third annular or peripheral portion of the bowl, or apron comprising at least one step, having a radial extent, L₁, said radial extent sufficient to cause a household pet having forelegs and hindlegs wherein the forelegs of the household pet engage the apron of the feeding bowl in order to feed wherein said apron engages a surface upon which the bowl is disposed at an angle, θ₁, ranging from 0 to about 30 degrees.

9. The bowl of claim 8 wherein the angle, θ₁, ranges from 1 degrees to 30 degrees.

10. The bowl of claim 8 wherein the bowl is circular.

11. The bowl of claim 8 wherein the bowl is square.

12. The bowl of claim 8 wherein the bowl is rectangular.

13. The bowl of claim 8 comprises a material of manufacture selected from the group consisting of china earthenware, porcelain, glass, wood, metal, and thermoplastics.

14. The bowl of claim 13 wherein the material is a thermoplastic.
